(19) United States
(12) Patent Application Publication
(10) Pub. No.: US 2014/0182141 A1
(43) Pub. Date: Jul. 3, 2014

(54) Scissors and Manufacturing Method Therefor

(71) Applicants: Stuart D. Farnworth, Fairfield, CT (US); Man For Ma, New Territories (HK); Sarah A. Albano, Fairfield, CT (US)

(72) Inventors: Stuart D. Farnworth, Fairfield, CT (US); Man For Ma, New Territories (HK); Sarah A. Albano, Fairfield, CT (US)

(21) Appl. No.: 13/732,858

(22) Filed: Jan. 2, 2013

(51) Int. Cl. B26B 13/02; B26B 13/20

(52) U.S. Cl. CPC B26B 13/02; B26B 13/20
USPC 30/254; 264/271.1

(57) ABSTRACT

A pair of scissors and a manufacturing method therefor involves forming an overmold comprising ABS material over a pair of blade members. TPR material is injection molded over the overmolds in limited amounts so that substantial portions of the overmolds remain exposed. The produced workpieces are pivotally joined to form a pair of scissors. One or more caps of ABS material or TPR material may be affixed to the overmolds to cover the pivot fastener.

### BACKGROUND

This disclosure relates generally to scissors and manufacturing methods for scissors. More particularly, this disclosure relates to scissors and methods which employ overmold materials.

Scissors and manufacturing techniques to which the present disclosure relates generally involve a pair of knife blades which include an integral shank. Pivot openings are then formed in the blade/shank components. Overmold materials, such as acrylonitrile butadiene styrene (ABS), are injection molded over the shanks to form handles. The pivot openings are then aligned and a pivot screw or fastener is inserted through the openings and secured to join the blades and form the scissors.

For some scissors, the screw is secured by a nut which engages one side of the blade or overmold material. In addition, a plug or a second overmold may be injection molded at the opposite side to cover the fastener head. Thermoplastic rubber material (TPR), which is a physical mix of polymers of a plastic and a rubber, is injection molded over the ABS material to improve the look, feel and usage of the scissors.

### SUMMARY

Briefly stated, a pair of scissors comprises a first scissor blade and a second scissor blade wherein each blade has an integral shank and an opening. The openings are aligned to define a pivot axis. A first overmold comprising ABS material is molded over the first shank and surrounds the pivot axis adjacent the first opening. The first overmold has a finger bow with an outer surface and an inner surface. A second overmold comprising ABS material is molded over the second shank and surrounds the pivot axis adjacent the second opening. The second overmold has a thumb bow with an outer surface and an inner surface. TPR material covers portions of the first overmold wherein the finger bow outer surface is not covered with TPR material. TPR material covers portions of the second overmold wherein the thumb bow outer surface is not covered with TPR material. A fastener is disposed in the openings to pivotally connect the first scissor blade and the second scissor blade.

The ABS material is preferably transparent or translucent plastic. The TPR material covering portions of the first overmold and portions of the second overmold has a TPR surface area which is less than 50% of the exterior surface area of the overmolds. The TPR exterior surface area is less than 25% of the overmold exterior surface area. Preferably, the TPR material is less than 15% by volume of the ABS material.

The first overmold has a front surface and a rear surface and the second overmold has a front surface and a rear surface. The TPR material covers portions of said front surface and said rear surface of each of the first and second overmolds. A plurality of narrow strips connects TPR material on the front surface and the rear surface of each overmold.

At least one cap, which can be formed from ABS material, is affixed to one of the overmolds and covers an end portion of the fastener. The first and second openings have first and second diameters. In one embodiment a cap formed from TPR material has a diameter larger than the first and second diameters and is affixed to an overmold and covers an end portion of the fastener. In another embodiment, a second cap opposite the first cap is also formed from TPR material.

A method of manufacturing a pair of scissors comprises overmolding ABS material over a portion of a first scissor blade having a first integral shank and defining a first opening and forming a finger bow with an outer surface and an inner surface. The method also comprises overmolding an ABS material over a portion of a second scissor blade having a second integral shank and defining a second opening and forming a thumb bow with an outer surface and an inner surface. The method includes injecting TPR material to cover portions of the first overmold without covering the finger bow outer surface with TPR material and also injecting TPR material to cover portions of the second overmold without covering the thumb bow outer surface with TPR material. The method also comprising aligning the first and second openings and inserting a fastener in the openings.

The ABS material is preferably transparent or translucent material is thin layers and the TPR material is preferably opaque.

The manufacturing method also comprises injecting TPR material to cover portions of the first overmold and the second overmold. The thin layers have an exterior surface area which is less than 50% of the exterior surface of the first and second overmolds. The injecting steps may also comprise injecting TPR material to cover portions of front and rear surfaces of each of the first and second overmolds. The TPR material is preferably injected to form narrow strips on the grip portion of both the thumb bow and the finger bow. The strips connect with the TPR material covering the front and rear surfaces of each of the overmolds. The manufacturing method further comprises forming strips of TPR material on the neck portion. The manufacturing method also comprises forming a cap on the overmold to cover the first or second openings such that one end of the fastener is covered. The method also comprises forming a pair of caps to cover the opposed ends of the fastener. In one preferred embodiment, TPR material is injection molded to form at least one cap covering an end of the fastener.

### BRIEF DESCRIPTION OF THE DRAWINGS

FIG. 1 is a perspective view of a representative pair of scissors;

FIG. 2 is a front view of the scissors of FIG. 1;

FIG. 3 is a rear view of the scissors of FIG. 1;

FIG. 4 is a side view of the scissors of FIG. 1;

FIG. 5 is an opposite side view of the scissors of FIG. 1;

FIG. 6 is a bottom plan view of the scissors of FIG. 1;

FIG. 7 is a top plan view of the scissors of FIG. 1;

FIG. 8 is a front view, partly in phantom, of a first workpiece illustrating a manufacturing step for the scissors of FIG. 1;

FIG. 9 is a rear view, partly in phantom, of the first workpiece of FIG. 8;

FIG. 10 is a front view, partly in phantom, of a second workpiece illustrating a manufacturing step for the scissors of FIG. 1;

FIG. 11 is a rear view, partly in phantom, of the second workpiece of FIG. 10;

FIG. 12 is a front view of a modified first workpiece for the workpiece of FIG. 8;

FIG. 13 is a rear view of the modified first workpiece of FIG. 12;

FIG. 14 is a front view of a modified second workpiece for the workpiece of FIG. 10;

FIG. 15 is a rear view of the modified second workpiece of FIG. 14;

FIG. 16 is an enlarged central sectional view of the scissors of FIGS. 1; and

FIG. 17 is an enlarged central sectional view of an alternate embodiment of the scissors of FIG. 1.

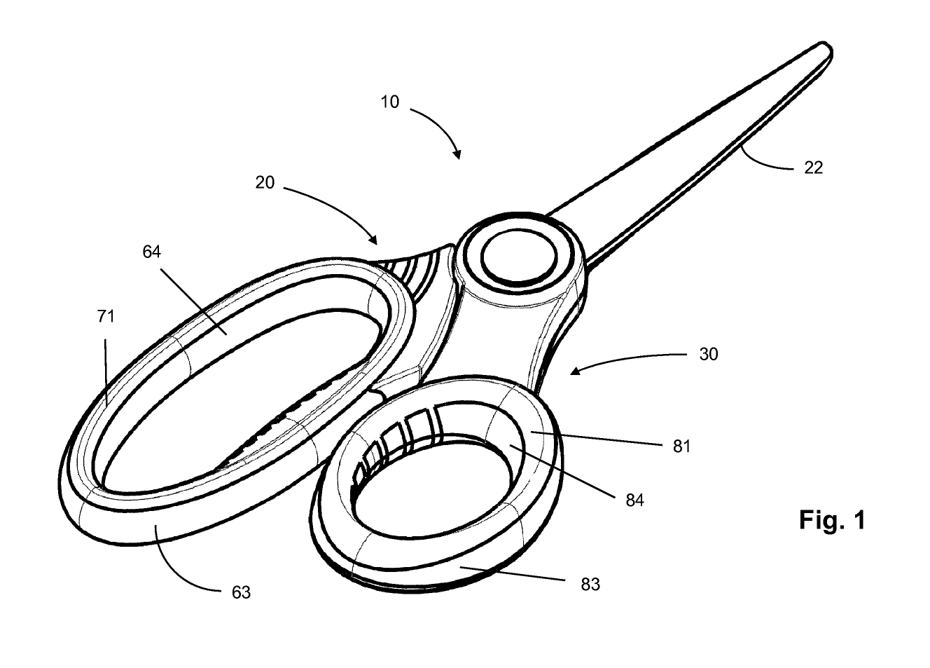

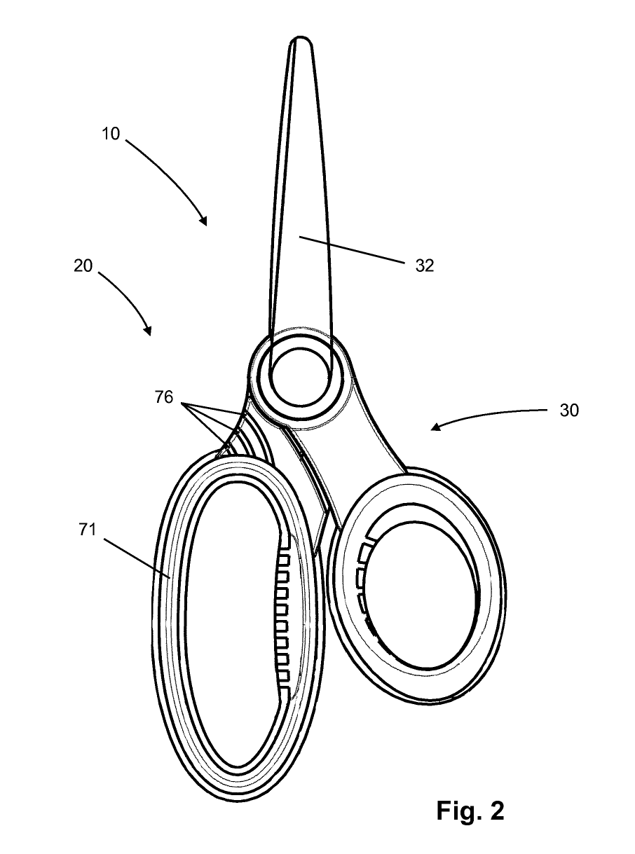

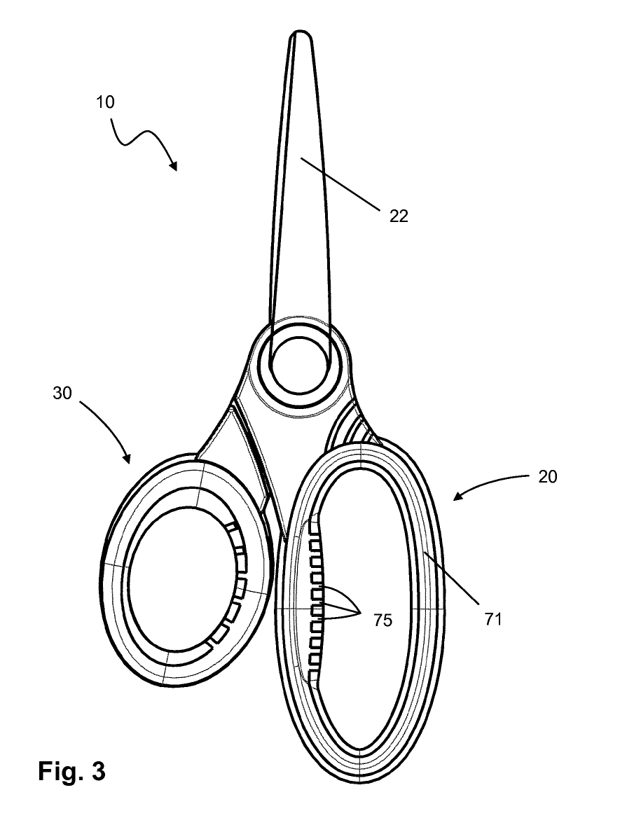

### DETAILED DESCRIPTION

With reference to the drawings wherein like numerals represent like parts throughout the several figures, a pair of scissors is generally designated by the numeral 10. The pair of scissors is representative of numerous scissor configurations and sizes and is manufactured according to an efficient manufacturing process, as will be described below.

The manufacturing process involves injection molding of acrylonitrile butadiene styrene (ABS) material and a limited quantity of thermoplastic rubber material (TPR) in a efficient process to provide a pair of scissors which are comfortable to use and have an aesthetically pleasing appearance.

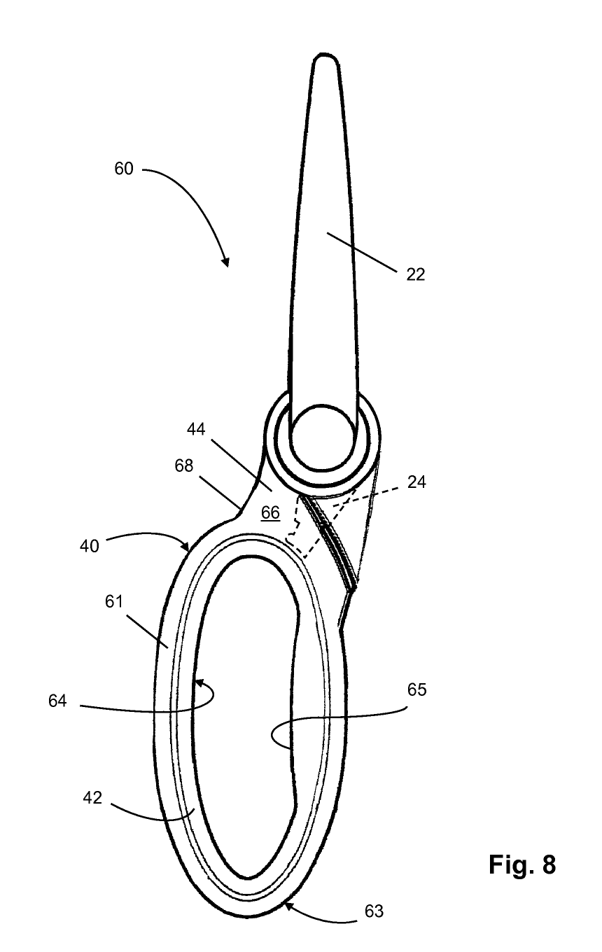

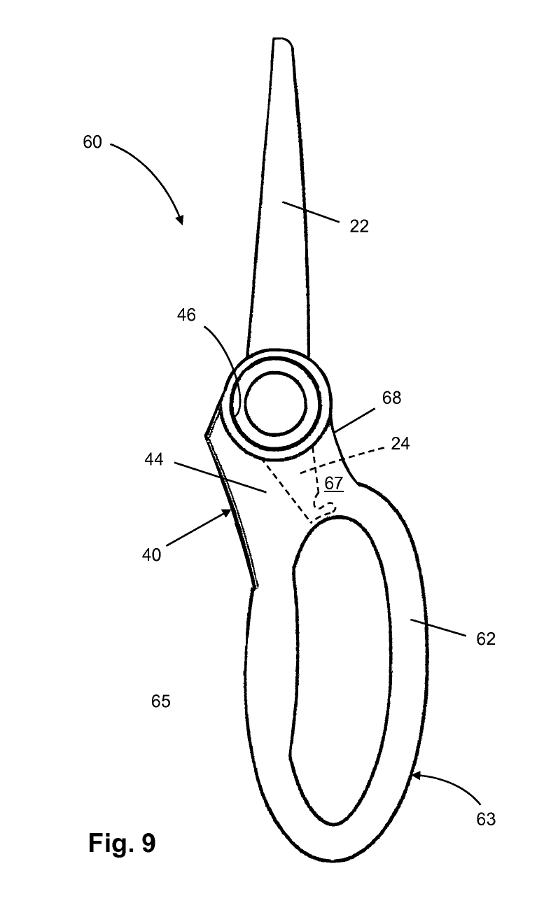

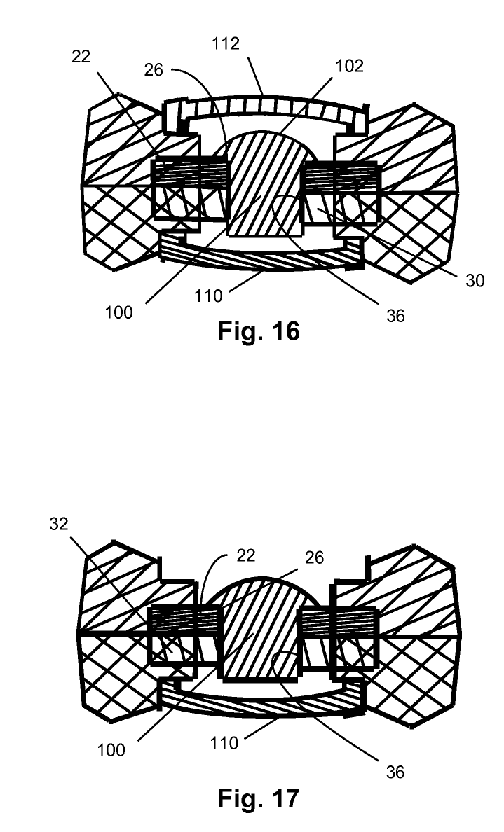

The scissors 10 comprise a first blade member 20 having a blade 22 and an oblique integral shank 24 (FIGS. 8, 9). A pivot opening 26 (FIGS. 16, 17) is formed at the intersection of the blade 22 and the shank 24.

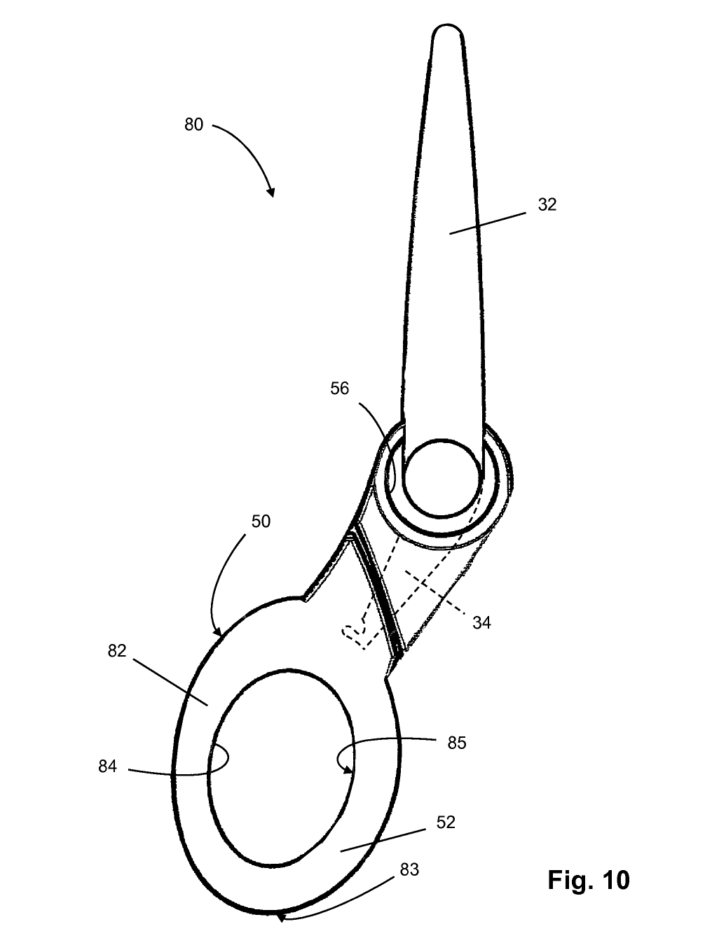

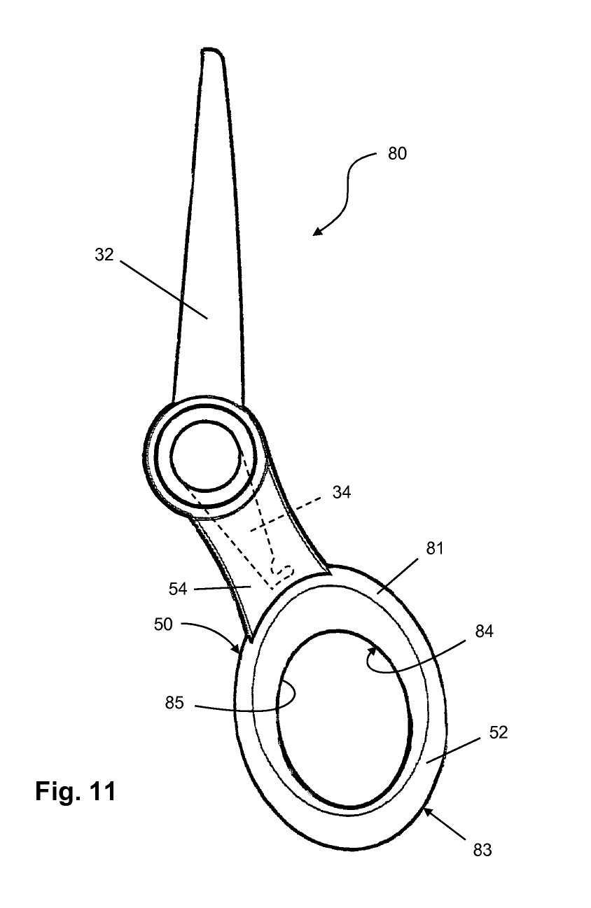

A second blade member 30 also has a blade 32 and an oblique integral shank 34 (FIGS. 10, 11) with a pivot opening 36 (FIGS. 16, 17) at the intersection of the blade 32 and the shank 34. Members 20 and 30 are preferably steel members and may also have a titanium composition.

With reference to FIGS. 8 and 9, ABS material is injected molded over member 20 to form a first overmold 40. The overmold 40 forms an elongated sculpted closed loop 42 with a neck 44 which receives shank 24. Loop 42 functions as a handle for receiving the fingers of a user of the assembled pair of scissors. The overmold 40 includes a recess 46 (FIG. 9) adjacent the opening 26 and surrounding an axis through the opening. The recess 46 is either annular or contoured in tapered fashion from the outer overmold surface to the opening. Various handle shapes and configurations may be provided to implement various ergonomic considerations. The member 30 and overmold 40 form a first workpiece 60.

With reference to FIGS. 10 and 11, ABS material injection molded over member 30 and in particular, the shank 34 to form a second overmold 50. The overmold 50 forms a smaller loop 52 which functions to receive the thumb of the user and a projecting neck 54 which receives blade 32. Again, the overmold may be configured in a wide variety of shapes and contours to accommodate the thumb of the user and ergonomic considerations. The overmold 50 also includes a recess, or crater 56 (FIG. 10) surrounding an axis through the opening 36. The member 30 and overmold 50 form a second workpiece 80.

The ABS material preferably is selected so that the overmolds 40 and 50 are transparent or translucent. Consequently, for preferred embodiments the shank 24, 34 may be visible through the overmolds.

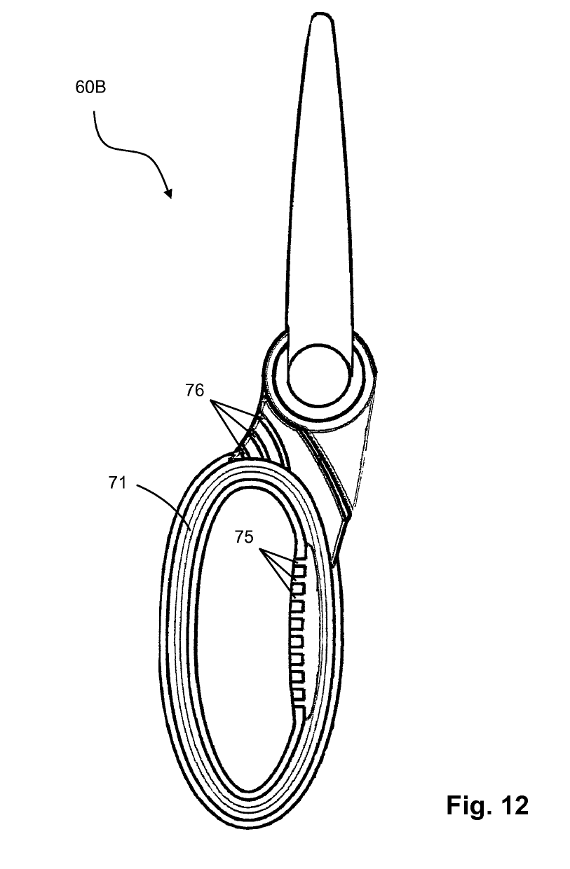

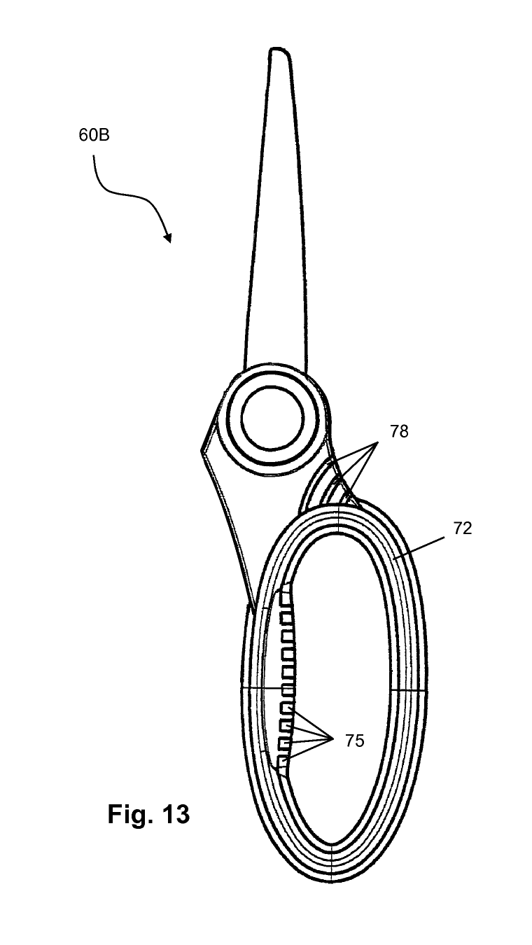

Workpiece 60 is placed in a mold and TPR material is injection molded in relatively thin layers to form a transformed workpiece 60B (FIGS. 12, 13). The initial workpiece 60 (FIGS. 8, 9) has a top 61 and a bottom 62 with an outer bow circumferential surface 63 and an inner bow circumferential surface 64 which includes a slightly protruding grip surface 65. The neck 44 extends from the bow and includes a top surface 66, a bottom surface 67 and a side surface 68.

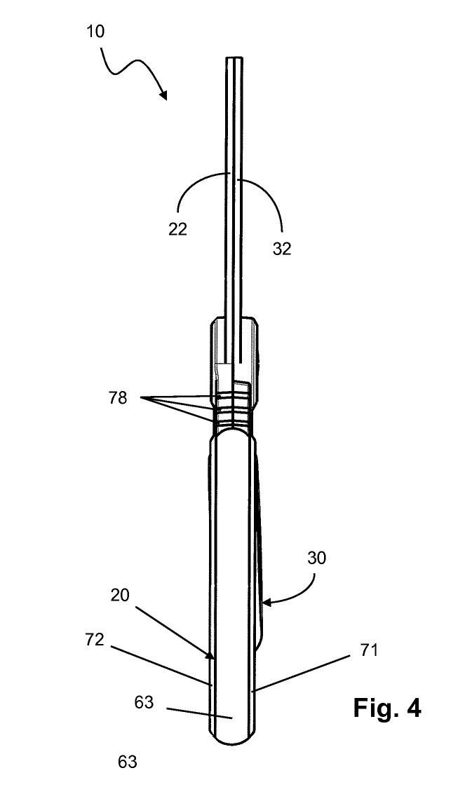

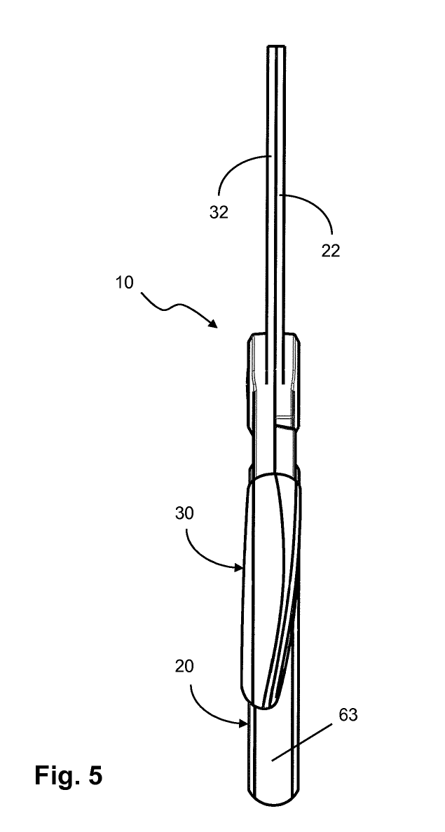

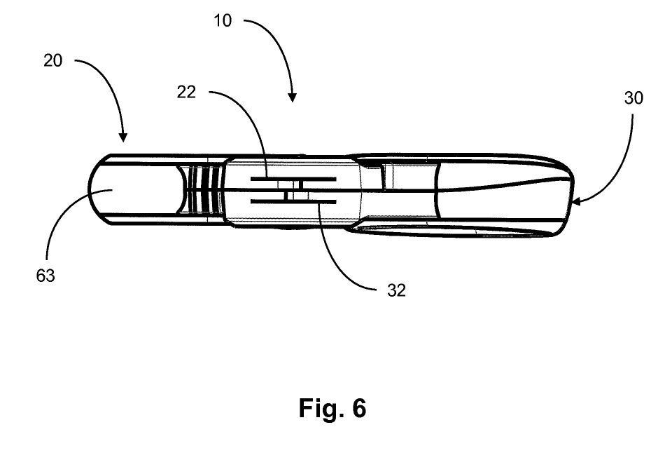

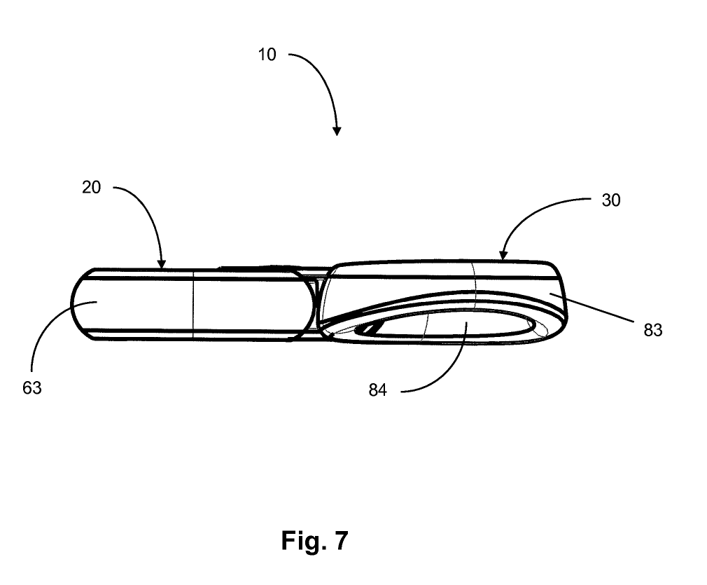

With additional reference to FIGS. 12 and 13, The TPR material is applied over the overmold in a highly restricted injection wherein the TPR forms a thin overlay 71 on the top 61, a thin overlay 72 on the bottom 62 and a series of connecting bands 75 across the grip portion 65. Overlays 71 and 72 have substantially the same shape and dimensions. In addition, there are preferably a few generally parallel connecting strips 76 which traverse the top surface 66 and continue to form strips 78 (FIG. 4) on side surface 68 and strips 77 on bottom neck surface 67 which connect with the overlay 71.

It will be appreciated that there is no TPR material whatsoever which covers the surface 63 and the only TPR material which covers the inner surface 64 are narrow bands 75 which traverse the grip portion. The TPR material is distributed in a highly efficient manner to provide a very effective grip on the workpiece 60B while most of the ABS overmold material is uncovered and remains exposed.

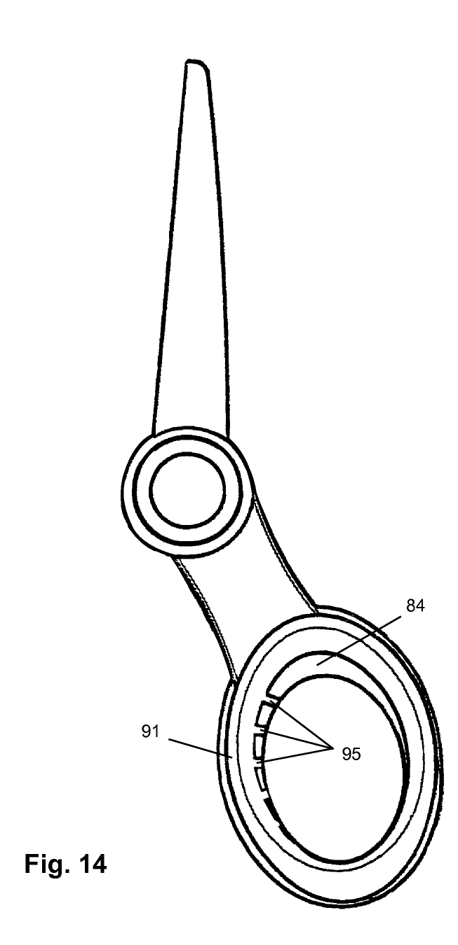

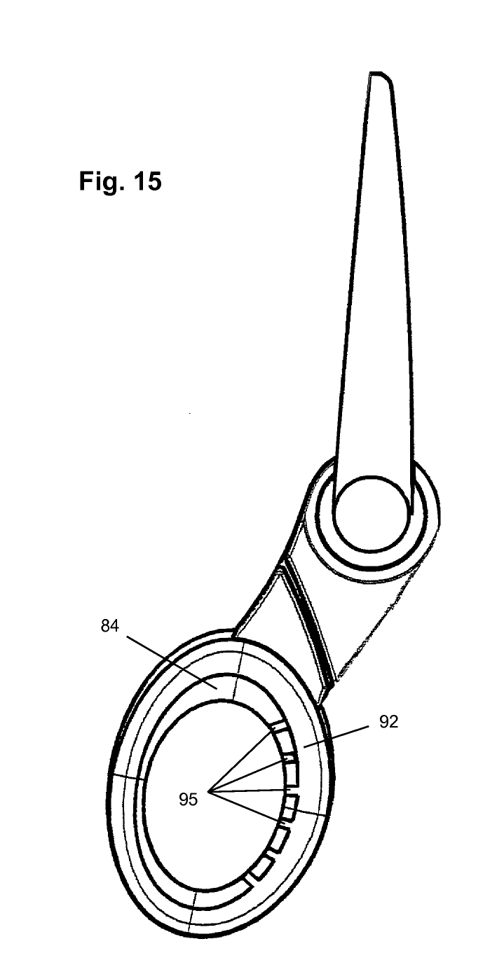

Workpiece 80 is placed in a mold and TPR material is injected in relatively thin layers to form transformational workpiece 80B (FIGS. 14, 15). Initial workpiece 80 (FIGS. 10, 11) includes a top surface 81, a bottom surface 82 and a side surface 83 which extends circumferentially around the outside of the thumb bow. An inner circumferential surface 84 extends at the interior of the thumb bow 52 and a contoured inner grip surface 85.

With reference to FIGS. 14 and 15, the TPR material forms a very thin surface overlay 91 on the top surface 81 and a very thin overlay 92 covering the bottom surface 82. Overlays 91 and 92 have substantially the same shape and dimensions. Thin narrow substantially parallel bands 95 extend from the overlays 91 and 92 across the grip surface 85. It will be appreciated that the outside surface 83 and most of the inside surface 84 is not covered by any TPR material. In addition, it is preferred that the neck 54 of the workpiece 80B also remains uncovered by any TPR material. Consequently, the TPR material forms a very efficient grip portion for the thumb bow 52 without the use of significant amount of TPR material.

For each of the workpieces 60B and 80B which now include the TPR covering, it is preferred that the covering material for layers 71, 72, 75, 76, 77, 78 and 91, 92, 95, 96, 97, 98 cover no more than 25% of the exposed surfaces of the ABS overmold and certainly less than 50%. By volume it is preferred that the TPR material is no more than 15% of the volume ABS material for the respective overmolds.

The workpieces 60B and 80B are then axially aligned along the openings 26 and 36 and a fastener 100 in the form of a rivet pin or threaded fastener is inserted through the openings to pivotally connect the workpieces. Various materials may be applied to cover the regions surrounding the pivot or fastening for the workpieces. In one embodiment, a cap 110 is applied on one side while the head 102 of the fastener 100 is visible at the opposing side. In another embodiment, caps 110 and 112 are injected molded or applied or affixed to both sides of the pivot area. The caps 110 and 112 may be composed of ABS material or TPR material.

In yet another embodiment, the workpieces 60 and 80 pivotally joined prior to injection of TPR material to form workpieces 60B and 80B. The injection molding step also involves injecting TPR material simultaneously in a single step to both sides of the recesses surrounding the pivot connection point axis of the workpiece to form TPR caps 110 and 112. Alternatively, only a single injection molding of TPR material may be applied to form a TPR cap on one side of the pivot area.

It will be appreciated that the scissors produced by the manufacturing method are aesthetically pleasing and highly efficient, wherein the TPR material provides an effective grip for pivotally operating the scissors and yet only a relatively small amount of TPR material is required to provide both an effective gripping surface as well as a very esthetically pleasing pair of scissors.

In one preferred embodiment, the ABS material is transparent or substantially transparent. The TPR material is preferably a soft-touch-type opaque material which may have a bright tint such as, for example, yellow, red, blue or any other striking color.

While preferred embodiments of the foregoing invention have been set forth for purposes of description, the foregoing description should not be deemed a limitation of the invention herein. Accordingly, various modifications, adaptations and alternatives may occur to one skilled in the art without departing from the spirit and the scope of the present invention.

1. A pair of scissors comprising:
a first scissor blade having a first integral shank and defining a first opening;
a second scissor blade having a second integral shank and defining a second opening aligned with said first opening to define a pivot axis;
a first overmold comprising ABS material molded over said first shank and surrounding said pivot axis adjacent said first opening, said first overmold having a finger bow with an outer surface and an inner surface;
a second overmold comprising ABS material molded over said second shank and surrounding said pivot axis adjacent said second opening, said second overmold having a thumb bow with an outer surface and an inner surface;
TPR material covering portions of said first overmold wherein said finger bow outer surface is not covered with TPR material;
TPR material covering portions of said second overmold wherein said thumb bow outer surface is not covered with TPR material; and
a fastener disposed in said first and second openings to pivotally connect said first scissor blade and said second scissor blade.

2. The scissors of claim 1 wherein said ABS material is transparent or translucent plastic.

3. The scissors of claim 1 wherein said first overmold and said second overmold together have an overmold exterior surface area, and TPR material covering portions of said first overmold and portions of said second overmold has a TPR exterior surface area which is less than 50% of said overmold exterior surface area.

4. The scissors of claim 3 wherein said TPR exterior surface area is less than 25% of said overmold exterior surface area.

5. The scissors of claim 1 wherein said TPR material is less than 15% by volume of said ABS material.

6. The scissors of claim 1 wherein said first overmold has a front surface and a rear surface, and said second overmold has a front surface and a rear surface, and said TPR material covers portions of said front surface and said rear surface of each said first overmold and said second overmold.

7. The scissors of claim 6 further comprising a plurality of narrow strips connecting TPR material on said front surface and said rear surface of each said overmold.

8. The scissors of claim 1 further comprising at least one cap affixed to a said overmold and covering an end portion of said fastener.

9. The scissors of claim 1 wherein said first and second openings have first and second diameters and further comprising a cap formed from TPR material having a diameter larger than said first and second diameters and affixed to a said overmold and covering an end portion of said fastener.

10. The scissors of claim 9 further comprising a second cap opposite said first cap wherein said second cap is formed from TPR material.

11. A method of manufacturing a pair of scissors comprising:
overmolding ABS material over a portion of a first scissor blade having a first integral shank and defining a first opening and forming a finger bow with an outer surface and an inner surface;
overmolding an ABS material over a portion of a second scissor blade having a second integral shank and defining a second opening and forming a thumb bow with an outer surface and an inner surface;
injecting TPR material to cover portions of said first overmold without covering said finger bow outer surface with TPR material;
injecting TPR material to cover portions of said second overmold without covering said thumb bow outer surface with TPR material;
aligning said first and second openings; and
inserting a fastener into said openings.

12. The manufacturing method of claim 11 further comprising employing ABS material which is a transparent or translucent material and employing TPR material which is opaque.

13. The manufacturing method of claim 11 wherein the first and second overmolds have an overmold exterior surface area and restrictively injecting TPR material to cover portions of said first overmold and said second overmold which is less than 50% of the overmold exterior surface area.

14. The manufacturing method of claim 11 wherein said first overmold and said second overmold each have a front surface and a rear surface and injecting said TPR material to cover portions of said front and rear surfaces of each said first second and overmolds.

15. The manufacturing method of claim 14 wherein said finger bow has an inwardly protruding grip portion and further comprising injecting TPR material to form bands on said grip portion wherein said bands connect between TPR material covering said front surface and said rear surface.

16. The manufacturing method of claim 14 wherein said thumb bow has a grip portion and further comprising injecting TPR material to form ands on said grip portion wherein said bands connect between TPR material covering said front surface and said rear surface.

17. The manufacturing method of claim 11 wherein said first overmold comprises a neck portion and further comprising forming strips of TPR material on said neck portion.

18. The manufacturing method of claim 11 further comprising forming a cap on a said overmold to cover said first or second opening.

19. The manufacturing method of claim 11 wherein said fastener has opposed ends and further comprising forming a pair of caps to cover the opposed ends of said fastener.

20. The manufacturing method of claim 11 further comprising injection molding TPR material to form at least one cap covering one end of said fastener.
